(19) United States
(12) Patent Application Publication
(10) Pub. No.: US 2010/0121796 A1
(43) Pub. Date: May 13, 2010

(54) SYSTEM AND METHOD FOR EVALUATING A GAS ENVIRONMENT

(76) Inventors: Heather A. Staines, San Diego, CA (US); Oscar E. Rodriguez, San Diego, CA (US); Marianne T. Dobrino, Esondido, CA (US); Holger H. Streckert, San Diego, CA (US)

Correspondence Address: NYDEGGER & ASSOCIATES, 348 OLIVE STREET, SAN DIEGO, CA, 92103, US

(21) Appl. No.: 12/266,709

(22) Filed: Nov. 7, 2008

(51) Int. Cl. G06N 3/08; G06F 19/00

(52) U.S. Cl. 706/20; 702/24

(57) ABSTRACT

A system and method for detecting gas concentrations in a target environment uses an array of sensors. Each sensor generates a respective voltammogram in response to the environment, and the voltammograms are collectively transformed into bins that each have a distribution and a height. Normalized bins are then matched with a training set to determine whether a selected gas is present. Also, an un-normalized bin is fitted with the training set to ascertain a concentration of the gas. For this operation, the training set includes normalized and un-normalized data references previously derived from empirically defined voltammograms.

The U.S. Government has a paid-up license in this invention and the right in limited circumstances to require the patent owner to license others on reasonable terms as provided for by the terms of Contract No. N00014-03-C-0316 awarded by Office of Naval Research.

### FIELD OF THE INVENTION

The present invention pertains generally to gas sensors. More particularly, the present invention pertains to gas sensors that are capable of determining whether a particular gas (gases) is (are) present in an environment and, if present, the concentration of the gas (gases). The present invention is particularly, but not exclusively, useful as a gas sensor that employs transformed voltammograms to ascertain gas concentrations, to thereby improve the accuracy, reliability and response time of the gas sensor.

### BACKGROUND OF THE INVENTION

Many examples can be given wherein the detection of gas concentrations in a target environment may be either beneficial, or necessary, or both. In any event, the task of detecting a gas concentration may be quite challenging, and can be both problematic and time consuming. Obviously, these constraints are to be avoided. The solution is to use reliable gas sensors, and to use them in an efficient manner.

Gas microsensors, such as cermet electrochemical cells, provide a well-known means for detecting gas concentrations. Specifically, it is known that these microsensors will give a specific current response whenever a voltage is applied to them. When the voltage is varied, the result is a current-voltage envelope that is commonly referred to as a voltammogram. Importantly, this current-voltage envelope (i.e. voltammogram) will change, depending on the gaseous environment in which the voltage is applied to the sensors. This is due to the fact that the reaction of gases with the surface electrodes of these sensors causes them to change their current response. Importantly, in each case, the resultant voltammogram will be specific for the sensor (i.e. its electrode composition), as well as for the gas concentration in which the sensor is activated.

As implied above, a voltammogram graphically presents current-voltage data in a manner that is characteristic of the gaseous environment in which the generating sensor is activated. Thus, as a practical matter, a voltammogram will typically include inputs from a variety of gases, and it will be influenced by the concentrations of the different gases. Stated differently, voltammograms will be of many different and varied sizes and shapes. Therefore, without more information, it can be an extremely difficult task to effectively and quickly analyze a voltammogram in real time, for a particular gas concentration in an operational setting. The situation is only further complicated when a plurality of voltammograms are involved.

It happens that information from a voltammogram can be mathematically transformed into a more useable format by employing mathematical transforms. In this context, the so-called wavelet transformations can be particularly effective. Specifically, such a transformation will result in so-called “bins” of data (also referred to hereinafter, in some contexts, as “data references”). Importantly, in comparison to the underlying voltammogram, these “bins” more succinctly identify the salient characteristics of detected gas concentrations. In general, this is so because each resultant “bin” is in a format that is more manageably presented as a distribution and a height. Moreover, in addition to its simplified format, only about 5% of the “bins” in the transformation of a typical voltammogram are required to accurately identify a gas concentration. With this in mind, the selection of a reduced number of “bins” can be rather easily accomplished using statistical probabilities.

It is axiomatic that the determination of a gas concentration requires the accomplishment of two, somewhat different tasks. First, it must be determined whether a particular gas is present in the target environment. Second, if the gas is present, its concentration must be ascertained. For the first task, the distribution and height format of the “bins” lend themselves to a matching procedure wherein the “bins” can be compared with empirically obtained data. For accomplishing the second task, this same format also facilitates the use of well-known “curve fitting” techniques.

In light of the above, it is an object of the present invention to provide a system and method for determining gas concentrations in an environment, wherein wavelet transformations are employed to convert information from voltammograms into more manageable data. Further, it is an object of the present invention to reduce the amount of this more manageable data by statistical selection to improve the operational response of the system. Another object of the present invention is to provide a system and method for determining gas concentrations in an environment that effectively provides a real time response. Still another object of the present invention is to provide a system and method for determining gas concentrations in an environment that is easy to use, is relatively simple to manufacture, and is comparatively cost effective.

### SUMMARY OF THE INVENTION

In accordance with the present invention, a device for detecting gas concentrations in an environment includes a sensor array having a plurality of individual sensors (e.g. four sensors). Importantly, each sensor is different from every other sensor in the array, and each of the individual sensors in the array has a unique, predetermined gas sensitivity. Also, a baseline is established for each sensor so that the background influence on the sensor is removed, before the device is activated.

When the sensors of the device are activated in a target environment, they generate a respective number of voltammograms. After they have been generated, the voltammograms are concatenated to create a collection of data points. The collection of data points is then compared with empirically obtained data to identify whether a particular gas is present. And, if so, its concentration is also ascertained.

To create the collection of data points, the device of the present invention includes a converter. Specifically, the converter is used to transform the collection of data points into a like number of bins that are each characterized by having both a distribution and a height. For the present invention, this transformation is preferably accomplished using a wavelet transformation. Further, the number of bins corresponding to a particular voltammogram can be reduced for operational purposes by statistical selection. Once transformed and selected, the bins are normalized, and un-normalized, for analysis by an evaluator. Specifically, this analysis by the evaluator is accomplished by respectively comparing the normalized and un-normalized versions of the selected bins with a training set.

As intended for the present invention, the training set (i.e. library) is empirically created. In particular, a sensor of each type that is to be incorporated into the operational device is used to generate a number of defined voltammograms for the training set. More particularly, each sensor is placed in a number of different, predetermined gaseous environments to generate a single defined voltammogram for each environment. Each defined voltammogram is then transformed to create data references (i.e. bins). Importantly, these transformations are accomplished using the same wavelet transformation that is to be subsequently used in the actual operation of the device. For the present invention, the transformed data references are then normalized, and un-normalized, to create the training set. Thus, the data references that are obtained from the defined voltammograms for the training set will correspond generally to the bins that are obtained from the voltammograms that are subsequently generated by sensors of the sensor array in the target environment.

In this way, the training set is established to include a plurality of normalized data references, and a plurality of un-normalized data references, that can be collectively used by the evaluator for direct comparison with the bins. As disclosed above, both the normalized and un-normalized versions of the bins are created in the target environment that is to be evaluated.

In operation, the device is activated in the target environment. Bins are then created as disclosed above. Normalized versions of the bins are then matched with normalized data references from the training set to identify the gas in the environment. Preferably, this matching is accomplished using a neural network. In a separate but coordinated operation, un-normalized versions of the bins are fitted with un-normalized data references from the training set to ascertain the concentration of the gas in the environment. Preferably, this fitting is accomplished using standard curve fitting techniques. The results are then displayed.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a general schematic of a device for the present invention;

FIG. 2 is a schematic of the components required to generate a training set for the present invention; and

FIG. 3 is a schematic of the operational components used by the present invention for the detection of a gas concentration in a specified environment.

### DESCRIPTION OF THE PREFERRED EMBODIMENTS

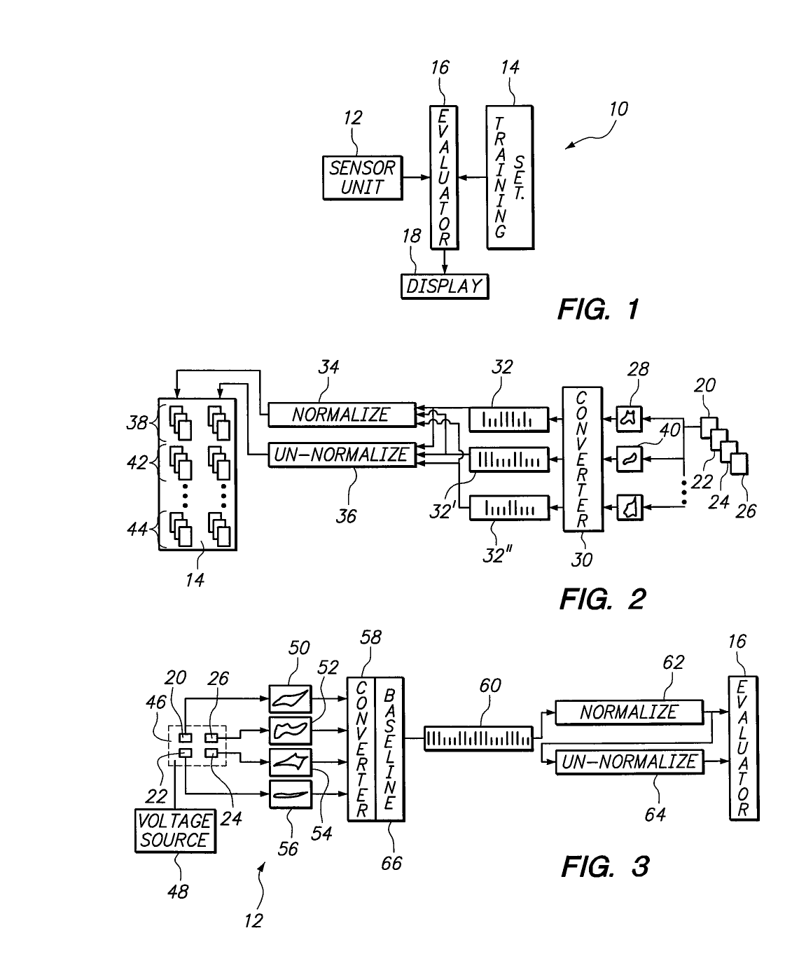

Referring initially to FIG. 1, a device for determining gas concentrations in an environment, in accordance with the present invention, is schematically shown and is generally designated 10. As shown, the device 10 includes a sensor unit 12 that is used for collecting data from a target environment (not shown) wherein the gas concentration is to be evaluated. The device 10 also includes a training set 14 that includes empirically obtained data for use in identifying a gas and its concentration in the target environment. Additionally, the device 10 includes an evaluator 16 that compares data obtained by the sensor unit 12 with empirical data in the training set 14. The result of this comparison is an identification of a gas and its concentration in the target environment. This information is then presented on the display 18 for use by an operator.

In detail, the creation of the training set 14 will be best appreciated with reference to FIG. 2. As indicated in FIG. 2, the training set 14 is created by collecting data from different cermet sensors 20, 22, 24 and 26. Although only the sensors 20, 22, 24 and 26 are shown in FIG. 2, this is only exemplary. As can be appreciated by the skilled artisan, many more such sensors could be used for the creation of the training set 14. Further, for purposes of this disclosure, the sensors 20, 22, 24 and 26 are preferably of the types disclosed in co-pending U.S. Patent Application entitled “Cermet Microsensor and Method of Making Same,” which is assigned to the same assignee as the present invention. With this in mind, the cermet sensor 20 is first considered individually, with the understanding that other such sensors are to be used in substantially the same way. Specifically, in order to create empirical data for the training set 14, the cermet sensor 20 is placed in an environment wherein a specific gas (e.g. H₂S), and its known concentration are predetermined. The sensor 20 is then activated by cyclically varying an applied voltage in an approximate range between ±1.5 volts. This will generate a voltammogram 28. The voltammogram 28 is then transferred to a converter 30.

For the present invention, the converter 30, shown in FIG. 2, is used for the present invention to transform voltammograms (e.g. voltammogram 28) into a plurality of data references 32. As envisioned, the transformations accomplished by the converter 30 are preferably done using a wavelet transformation, such as Daubechie-8, which is a type of transformer that has been shown to be very effective in achieving significant data reduction. Further, the data references 32 that result from the transformation of the voltammogram 28 are subject to a selection process in which only statistically significant data references 32 are retained. Specifically, this is done in order to reduce the amount of data that is eventually contained in the training set 14. As determined for the present invention, it happens that as few as about 5% of the transformed data references 32 are statistically significant. The result of this transformation and selection process in the converter 30 is exemplarily shown in FIG. 2 as the data references 32, 32′ and 32″. In reality, however, there may be as many as several hundred statistically significant data references 32 for each voltammogram, such as the voltammogram 28. In each case, the data references 32 will collectively include information that is pertinent to the salient characteristics of the gas environment where the cermet sensor 20 was activated.

Still referring to FIG. 2, it will be seen that all of the statistically selected data references 32 are normalized (block 34), and un-normalized (block 36). Both the normalized and un-normalized versions of the data references 32 are then stored in a sub-set 38 of the training set 14, pertinent to the sensor 20, for subsequent retrieval. Creation of the training set 14 is then continued by acquiring data from the sensor 20 in other different, predetermined gas environments. Each time, a different voltammogram 40 is generated that is characteristic of the particular environment in which it was generated. Again, for each voltammogram, the converter 30 transforms and selects data references 32 that are normalized and un-normalized for eventual inclusion in the sub-set 38 of training set 14. This continues, with sequential activations of the cermet sensor 20, for as many different predetermined gas environments, as desired. And, each time, the resultant voltammogram is transformed and normalized and un-normalized into data references 32 for inclusion in the sub-set 38.

After the sub-set 38 has been completed for the cermet sensor 20, the same process is used for the cermet sensor 22, the cermet sensor 24 and the cermet sensor 26. For example, the cermet sensor 22 can be used to create the sub-set 42, and the cermet sensor 26 can be used to create the sub-set 44. The consequence of this is the creation of a training set 14 that includes transformed and statistically selected empirical data that is obtained from a plethora of voltammograms. As described above, each voltammogram is specific for a particular sensor (e.g. cermet sensor 20) and for a predetermined gas concentration.

Returning now to FIG. 1 it will be appreciated that the training set 14 that is created as described above is an integral component of the device 10. Specifically, both the training set 14 and the sensor unit 12 are directly connected to the evaluator 16. Turning now to FIG. 3, details of the sensor unit 12 are disclosed, and its interrelationship with the training set 14 is presented in greater detail.

In FIG. 3 it is seen that the cermet sensors 20, 22, 24, and 26 are mounted as an array 46, and that the array 46 is powered by a voltage source 48. As envisioned for the device 10 of the present invention, each sensor 20, 22, 24 and 26 in the array 46 will generate its own voltammogram in response to a cycle of applied voltage from the voltage source 48. For example, when the sensor 20 is cycled it will generate a voltammogram 50. Similarly, the sensor 22 will generate a voltammogram 56 and, likewise, the sensors 24 and 26 will respectively generate voltammograms 54 and 52. These voltammograms 50, 52, 54 and 56 are then passed to a converter 58 where they are concatenated and transformed by the wavelet transformation into bins 60. Thus, mathematically, the bins 60 have similar characteristics to that of the data references 32 discussed above. As shown in FIG. 3, the bins 60 are sequentially normalized 62 and un-normalized 64 for access by the evaluator 16.

In the operation of the device 10 of the present invention, the array 46 of sensors 20, 22, 24 and 26 are first cleared. Specifically, this clearing is done by cycling all of the sensors in the array 46 to establish a baseline 66 for the device 10. This baseline 66 effectively represents the background noise for the device 10, and it will be subsequently mathematically subtracted from readings taken by the device 10. In any event, when used, all of the sensors 20, 22, 24 and 26 in the array 46 are voltage cycled in the target environment. The voltammograms 50, 52, 54 and 56 that result from activation of the array 46 are then transformed by the converter 58 into bins 60. And, normalized and un-normalized versions of the bins 60 are prepared. The evaluator 16 then compares the bins 60 with the data references 32 in the training set 14. Specifically, normalized bins 60 are matched with normalized data references 32 to determine whether a particular gas is present in the target environment. If the gas is present, un-normalized bins 60 are curve fitted with un-normalized data references 32 to determine, by extrapolation, the concentration of the gas.

While the particular System and Method for Evaluating a Gas Environment as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for detecting gas concentrations in an environment which comprises:
a sensor array having a plurality of individual sensors, wherein each individual sensor in the array has a unique predetermined gas sensitivity;
a voltage source for activating sensors in the array to generate a collection of data points indicative of gas concentrations in the environment;
a converter for transforming the collection of data points into a plurality of bins, wherein each bin has a distribution and a height, and for statistically selecting bins for further analysis; and
an evaluator for analyzing the plurality of selected bins in comparison with a training set to identify whether a particular gas is present in the environment and to ascertain a concentration of the gas in the environment.

2. A system as recited in claim 1 wherein the collection of data points is obtained from a plurality of voltammograms generated by a respective plurality of sensors, wherein a baseline is established for each voltammogram, and further wherein each voltammogram is transformed by the converter using a wavelet transformation.

3. A system as recited in claim 2 wherein the training set comprises a plurality of data references, and the bins are normalized for comparison with normalized data references from the training set to identify the gas in the environment, and the bins are un-normalized for comparison with un-normalized data references from the training set to ascertain the concentration of the gas in the environment.

4. A system as recited in claim 3 further comprising a neural network for comparing normalized bins with normalized data references.

5. A system as recited in claim 3 further comprising a curve fitter for comparing the un-normalized bin with un-normalized data references.

6. A system as recited in claim 3 wherein each data reference in the electronic training set includes information obtained from a respective empirically defined voltammogram.

7. A system as recited in claim 6 wherein each empirically defined voltammogram is specific for one sensor in the array, is specific for at least one gas, and is specific for a concentration of the at least one gas in the environment.

8. A system as recited in claim 7 wherein each empirically defined voltammogram is transformed, using the wavelet transformation, to create data references for inclusion in the training set.

9. A system as recited in claim 1 wherein the sensor array includes four sensors.

10. A method for detecting gas concentrations in an environment which comprises the steps of:
positioning a plurality of sensors in the environment;
generating a plurality of voltammograms from a respective plurality of sensors;
establishing a baseline for each voltammogram to remove background therefrom;
concatenating the voltammograms to produce a collection of data points;
transforming the collection of data points to create a like number of bins;
statistically selecting a predetermined number of bins;
normalizing the selected bins;
matching the normalized bins with a training set to identify the gas in the environment;
un-normalizing the selected bins; and
fitting the un-normalized bins with the training set to ascertain a concentration for the gas in the environment.

11. A method as recited in claim 10 wherein the training set comprises a plurality of data references and each data reference is created by the steps of:
producing an empirically defined voltammogram; and
transforming each defined voltammogram into a plurality of data references.

12. A method as recited in claim 11 wherein the transforming step is accomplished using a wavelet transformation.

13. A method as recited in claim 11 further comprising the steps of:
normalizing the data references for use in the matching step; and
un-normalizing the data references for use in the fitting step.

14. A method as recited in claim 11 wherein the matching step is accomplished using a neural network.

15. A method as recited in claim 11 wherein the fitting step is accomplished using curve fitting techniques.

16. A method as recited in claim 11 wherein each defined voltammogram is specific for one sensor in the plurality of sensors, is specific for at least one gas, and is specific for a concentration of the at least one gas in the environment.

17. A method for detecting gas concentrations in an environment which comprises the steps of:
providing a device having a voltage source, a converter, an evaluator and a plurality of individual sensors, with each individual sensor having a unique predetermined gas sensitivity;
activating the sensors with the voltage source to generate a collection of data points;
transforming the collection of data points with the converter into a plurality of bins, wherein each bin has a distribution and a height;
statistically selecting a predetermined number of bins for analysis; and
analyzing the selected bins with the evaluator, in comparison with a training set, to identify whether a particular gas is present in the environment and to ascertain a concentration of the gas in the environment.

18. A method as recited in claim 17 wherein the activating step further comprises the steps of:
generating a plurality of voltammograms from a respective plurality of sensors;
establishing a baseline for each voltammogram to remove background therefrom; and
concatenating the voltammograms to produce the collection of data points.

19. A method as recited in claim 18 further comprising the steps of:
normalizing the selected bins; and
matching the normalized bins with the training set to identify the gas in the environment.

20. A method as recited in claim 19 further comprising the steps of:
un-normalizing the selected bins; and
fitting the un-normalized bins with the training set to ascertain a concentration for the gas in the environment.
